(19) United States
(12) Patent Application Publication
(10) Pub. No.: US 2024/0019527 A1
(43) Pub. Date: Jan. 18, 2024

(54) METHOD AND APPARATUS THAT USES A TRANSMISSION FROM A SINGLE TRANSMITTER FOR RECEIVER POSITIONING

(71) Applicant: FOCAL POINT POSITIONING LIMITED, CAMBRIDGE (GB)

(72) Inventors: RAMSEY MICHAEL FARAGHER, CAMBRIDGE (GB); ROBERT MARK CROCKETT, CAMBRIDGE (GB); PETER JAMES DUFFETT-SMITH, CAMBRIDGE (GB)

(21) Appl. No.: 18/222,642

(22) Filed: Jul. 17, 2023

Related U.S. Application Data
(60) Provisional application No. 63/389,451, filed on Jul. 15, 2022.

(51) Int. Cl. G01S 5/02; G01S 13/58; G01S 3/02; G01S 5/00

(52) U.S. Cl. CPC G01S 5/0242; G01S 13/582; G01S 3/023; G01S 5/017

(57) ABSTRACT

A method, apparatus and system for providing a position of a receiver using signals transmitted from a single transmitter include receiving a plurality of signals transmitted from the single transmitter, determining a motion of an antenna of the receiver, generating a plurality of phasors sequences, compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results, determining a preferred hypothesis in the plurality of hypotheses for each received signal that optimizes each correlation result, identifying a direction of arrival for the plurality of received signals using the preferred hypothesis, and determining a position of the receiver using the direction of arrival of each received signal in the plurality of received signals.

### CROSS-REFERENCE TO RELATED APPLICATIONS

This application claims benefit of U.S. Provisional Patent Application Ser. No. 63/389,451 filed Jul. 15, 2022, which is herein incorporated by reference in its entirety.

### BACKGROUND

### Field

Embodiments of the present invention generally relate to radio signal processing and, in particular, to a method, apparatus and system for processing radio signals to perform receiver positioning.

### Description of the Related Art

Radio transmissions are used in various communications and positioning systems. For example, WiFi, using the IEEE 802.11a, b, g, n, ac standards, has become ubiquitous for short range data communications. WiFi access points (also referred to as WiFi hotspots) comprise radio transceivers that broadcast 2.4 or 5 GHz signals using a narrowband signal (e.g., 20 MHz). These access points can be used for low accuracy position location. Typically, received signal strength measurements of multiple such access point transmissions received at a receiver of a WiFi enabled device can be used by the receiver to estimate its distance from each transmitter, allowing the receiver to determine its approximate position relative to the transmitters through trilateration. Indoor position accuracy is 5-8 meters at best.

Some WiFi positioning techniques use signal characteristics of wireless access points to position connected devices. By knowing the ground truth position of access points and the signal strength detected by WiFi enabled devices, a receiver can provide location information by listening to access point signals without connecting to WiFi network. This WiFi location approach has several advantages:
(1) It can work in areas where satellite positioning systems are unreliable, such as in dense urban areas and indoors.
(2) It uses existing Wi-Fi infrastructure to work, without any additional hardware installation, making it an affordable positioning option.

Some WiFi positioning techniques use signal fingerprint techniques in which a database of signal strength measurements at each given location is stored and used to predict future positions. To remove ambiguities in positioning, multiple non-co-located transmitters can be implemented.

To create a functional positioning system, several WiFi transmitters need to exist in a given location. The narrowband nature of the signals severely constrains the functionality of the receiver when exposed to multipath signals. The reflected narrowband WiFi signals overlap in a multipath situation such that the receiver cannot discriminate between signals arriving directly from a transmitter and those that are reflected from objects or walls. As such, in a multipath environment, the receiver may not be able to derive a position at all. Additional transmitters can be implemented to ensure that the receiver also receives signals directly from the transmitter with a very high signal strength. The implementation of additional transmitters, however, adds complexity and cost to a positioning system.

Therefore, there is a need for a method, apparatus and system that uses a transmission signal from a single transmitter for determining receiver positioning.

### SUMMARY

Embodiments of the present invention generally relate to a method, apparatus and system that uses a transmission from a single transmitter for determining receiver positioning.

A method, apparatus and system for providing a position of a receiver using signals transmitted from a single transmitter include receiving a plurality of signals transmitted from the single transmitter, determining a motion of an antenna of the receiver, generating a plurality of phasors sequences, compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results, determining a preferred hypothesis in the plurality of hypotheses for each received signal that optimizes each correlation result, identifying a direction of arrival for the plurality of received signals using the preferred hypothesis, and determining a position of the receiver using the direction of arrival of each received signal in the plurality of received signals.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A depicts a graphic representation of a communication environment in which an embodiment of a receiver of the present principles is located in a first position in a room. in accordance with at least one embodiment;

FIG. 1B depicts a graphic representation of a communication environment in which an embodiment of a receiver of the present principles is located in a second position in the room in accordance with at least one embodiment;

FIG. 2 is a block diagram of the receiver of FIGS. 1A and 1B in accordance with at least one embodiment of the invention;

FIG. 3 depicts the operation of a receiver of the present principles in a communication room in accordance with at least one embodiment of the present principles;

FIG. 4 depicts a flow diagram of a method for determining a position of a receiver using signals transmitted from a single transmitter in accordance with an embodiment of the present principles; and

FIG. 5 depicts a flow diagram of a method 500 of operation of the positioning software 232 in accordance with at least one embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles include methods, apparatuses, and systems that can implement a transmission from a single transmitter for determining positioning information of a receiver.

While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific signals originating from specific transmitters and being received by specific receivers, embodiments in accordance with the present principles can be applied to substantially any radio signals originating from substantially any signal source and being received by substantially any receiver.

In some embodiments, digital communication systems, such as cellular, Bluetooth and/or WiFi utilize encoded digital signals to improve communication throughput and security. Such systems utilize a form of deterministic digital code, e.g., acquisition codes, to facilitate signal acquisition. Such a digital code can be determined by the receiver and repeatedly broadcast by the transmitter to enable receivers to acquire and receive the transmitted signals. Using such deterministic codes combined with an accurate motion model of a receiver, embodiments of the present principles enable determination of a signal propagation path along a specific direction of arrival (DoA). The signal can propagate directly (e.g., line-of-sight (LOS)) or via a reflection (e.g., non-line-of-sight (NLOS)). The technique for performing this DoA determination using receiver motion information is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. In some embodiments, a receiver and transmitter are operating within a room. A receiver of the present principles can use DoA data determined for transmissions from a single transmitter in combination with a map (e.g., a floor plan) of the room and the location of the transmitter within the room to determine the position of the receiver within the room. The computed position of the receiver is relative to the known location of the transmitter. As such, in such embodiments of the present principles, DoA data (i.e., azimuth and elevation) is not necessary, and data regarding angle of arrival (AoA) (e.g., azimuth) will be enough for deriving a position of the receiver. Although in the following description DoA data is implemented to determine a position of a receiver, it should be understood that AoA data can be substituted for DoA data in situations in which elevation data is not necessary.

In some embodiments, a receiver is transported through a room containing a single transmitter (e.g., WiFi, Bluetooth, or cellular) and receives signals from several propagation paths (LOS and NLOS). In some embodiments, the received signals can include signals from a transmitter that transmits a narrow bandwidth signal, e.g., about 20 MHz. Having knowledge of the location of the transmitter (i.e., via a WiFi access point or hotspot) and knowledge of the room dimensions (i.e., via a floor plan), a receiver of the present principles is able to determine the propagation paths for the received signals (e.g., the LOS and NLOS signals). For example, in some embodiments, the receiver isolates the LOS and NLOS signals to use all the signals as if they were transmitted by different transmitters from different directions having different transmission path lengths (i.e., a virtual transmitter is defined at each reflection point of the NLOS signals). A processing of these isolated signals in accordance with the present principles, and as described in further detail below, results in a position determination for the receiver. The described functionality of embodiments of the present principles can be embedded into cellular telephones, Internet of Things (IoT) devices, mobile computers, tablets, positioning tags and the like. That is, embodiments of the present principles can find use on any moving device that receives signals having a code that can be correlated with a locally generated code. Embodiments may be useful in processing low bandwidth signals that are particularly difficult to use for location purposes. A receiver of the present principles need only be able to utilize the deterministic acquisition code contained in the received signal. Although the receiver may receive the signal and utilize a full data message of the signal (i.e., WiFi, Bluetooth or cellular enabled), the receiver does not have to be fully enabled.

In accordance with embodiments of the present principles, as a receiver traverses an area, the receiver determines DoA data for the transmitter and the virtual transmitters formed by signal reflections. In at least some embodiments, at least two versions of the transmitted signal (two reflected signals, or a direct and reflected signal) are needed to determine a receiver position. The received signals appear to the receiver as multiple signals transmitted from the direct (actual transmitter) and reflection points (synthetic transmitters) and include synchronized clocks from the transmitter. The receiver of the present principles is capable of extracting clock error between the transmitter clock and receiver clock because the clock error is common to all received signals. When the receiver is stationary, the clock error is the only frequency offset that is evident in the correlation results. Consequently, the position error otherwise caused by this clock error can be mitigated (or otherwise removed or compensated) to enable calculation of an accurate position for the receiver.

By identifying a direction of arrival for each of a plurality of received signals, the position of the receiver may advantageously be determined using signals received from a single (e.g. WiFi) transmitter that have travelled along different propagation paths between the transmitter and receiver, and therefore have different angles of arrival at the receiver. Additionally, determining a receiver position based on the angle of arrival of a plurality of received signals provides increased positioning accuracy compared to using conventional techniques that are based on signal strength measurements. Through determining receiver position based on signals received from a single transmitter, such as a WiFi access point, embodiments of the present principles finds particular advantage in environments where satellite positioning systems are unreliable, such as dense urban areas and indoor environments.

In some embodiments, the receiver can initially know its approximate position through the use of a global navigation satellite system (GNSS) and/or an inertial guidance system associated with the receiver. The receiver can also know an initial position of a door through which the receiver enters a room (or other landmark) and can use the door/landmark position as a starting position. From the receiver approximate position, a plurality of DoA vectors, a known location of the transmitter and room dimensions (i.e., room map or floor plan), embodiments of a receiver of the present principles can accurately compute the position of the receiver relative to the transmitter location. The determined relative position within the room can then be translated to a geocoordinate. As receiver positions are determined, a geocoordinate map can be produced identifying the positions of the receiver as it moves. As such, embodiments of the present principles can provide a method, apparatus, and system for generating improved simultaneous location and mapping (SLAM) within an indoor space that is served by a single transmitter.

Although the embodiment described above uses a single transmitter, other embodiments of the present principles can implement multiple transmitters where signals from each transmitter can be processed in the manner described for the single transmitter above to determine independent position estimations for the receiver. In some embodiments, the respective positions for the receiver determined by processing the signals from each transmitter can be combined to more accurately determine a position for the receiver.

In some embodiments, signal processing can be performed locally on the moving platform. Alternatively or in addition, the transmitter location, room dimensions, receiver motion information, and receiver position information can be gathered at the moving platform and communicated (wired or wirelessly) to a server for remote processing in real-time or at a later time.

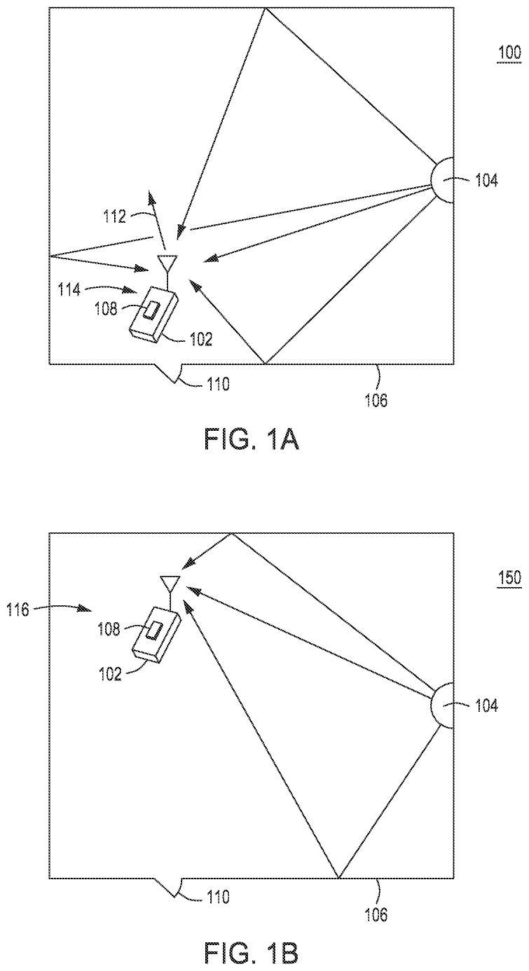

FIG. 1A depicts a graphic representation of a communication environment 100 in which an embodiment of a receiver 102 of the present principles is located in a first position in a room. FIG. 1B depicts a graphic representation of a communication environment 150 in which an embodiment of a receiver 102 of the present principles is located in a second position in the room. In the embodiments of FIG. 1A and FIG. 1B, the receiver 102 receives signals broadcast from a single transmitter 104 in accordance with at least one embodiment of the present principles. In the embodiment of FIG. 1A, the receiver 102 has entered a room 106 at position 114. In the embodiment of FIG. 1B, the receiver 102 has moved through the room 106 to position 116. As the receiver 102 moves through the room 106, the receiver 102 receives signals from the signal transmitter 104 and determines an accurate receiver position in accordance with the present principles described herein. In the embodiments of FIG. 1A and FIG. 1B, the receiver 102 is operating in a high multipath environment such as indoors within the room 106. In other embodiments, the receiver 102 can be operating in an urban canyon having buildings or other reflective structures proximate the receiver 102. As depicted in the embodiments of FIG. 1A and FIG. 1B, the receiver 102 includes a positioning module 108 configured to receive and process signals transmitted by the transmitter 104.

That is, in the embodiment shown in FIG. 1A, the receiver 102 enters the room 106 knowing its approximate position either from: (1) a global navigation satellite (GNSS) receiver and/or an inertial navigation system (INS) or (2) position knowledge from a map (e.g., enter through a door 110 or other landmark with a known location within the room 106). The positioning module 108 uses a known location of the transmitter 104 within the room 106, the known receiver initial position, a map or floor plan of the room and receiver motion information (a motion model) in combination with the received signals that arrive directly from the transmitter (LOS signals) and reflected signals (NLOS signals) to determine an accurate receiver position as the receiver traverses the room to position 116 of FIG. 1B.

As described in detail below, the at least one receiver 102 uses a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. The technique determines a direction of arrival (DoA) of signals received at a receiver (i.e., received signals) from the transmitter—both LOS and NLOS signals. As the receiver 102 moves (represented by arrow 112), the positioning module 108 computes motion information representing motion of the receiver 102. The motion information is used to perform motion compensated correlation of the received signals. From the motion compensated correlation process, the positioning module 108 estimates the DoA of the received signals. The positioning module 108 uses the room map and the transmitter location along with the DoA data to determine a location of the receiver 102. The intersection of a plurality of DoA vectors generated as the receiver moves along path 112 can be used to identify the location of the receiver 102 as described in detail below.

In some embodiments, the DoA vectors are used to isolate received signals and time of arrival (TOA) or time difference of arrival (TDOA) techniques can be used to process correlation results associated with the isolated signals to determine the receiver position. In some embodiments, received signal strength can also be used to improve or augment the position calculation using DoA and/or TOA. Note that, because the positioning module 108 can discern the DoA of the narrowband signals which overlap in a multipath environment, the positioning module can isolate reflected signals and use those signals as if they were transmitted by transmitters located at the image points (i.e., the image points form virtual transmitter locations).

In one embodiment, the single transmitter is a WiFi transmitter having transmissions at about 2.4 GHz or 5 GHz with a signal bandwidth of 20 MHz. Other embodiments can operate using other signals such as from Bluetooth (i.e., a 1 MHz channel width) or cellular (i.e., ranging from 1 to 20 MHz depending on the standard) transmitters having fixed, known locations. In other embodiments, the single transmitter can have a known moving location, such as a known trajectory. Such examples include a positioning or communications satellite, from which the receiver can receive multiple signals due to reflections (e.g. off building surfaces).

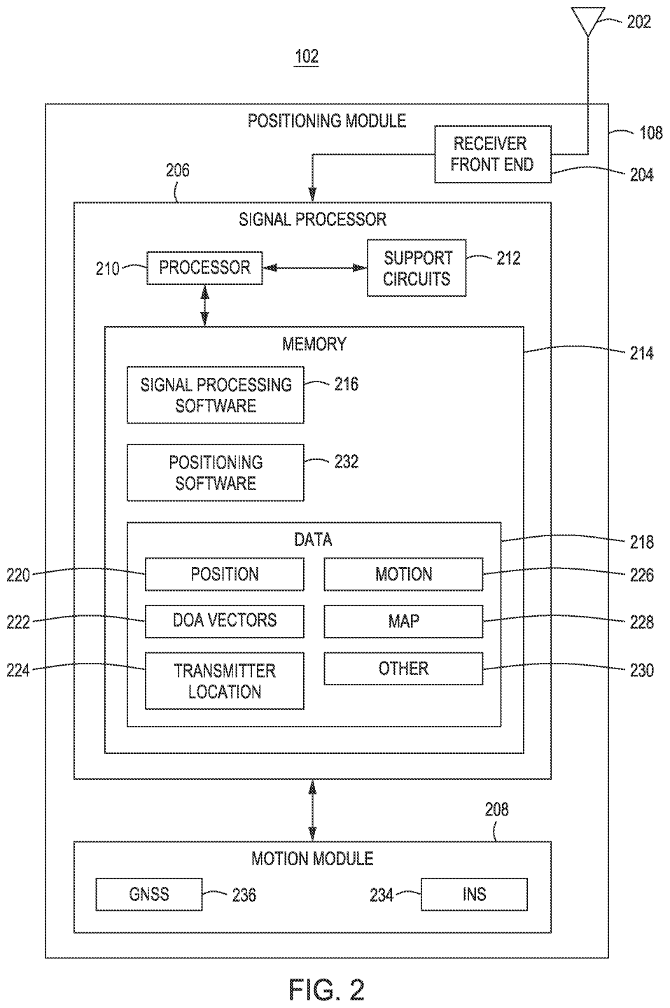

FIG. 2 is a block diagram of a receiver of the present principles, such as the receiver 102 of FIG. 1, in accordance with at least one embodiment of the present principles. The receiver 102 of FIG. 2 illustratively comprises a mobile platform 200, an antenna 202, a receiver front end 204, a signal processor 206, and a motion module 228. The receiver 102 can comprise a portion of a laptop computer, mobile phone, tablet computer, Internet of Things (IoT) device, purpose built positioning device, etc.

In the receiver 102 of FIG. 2, the positioning module 108 and the antenna 202 are an indivisible unit where the antenna 202 moves with the positioning module 108. The operation of the SUPERCORRELATION™ technique operates based upon determining the motion of the signal receiving antenna. Any mention of motion herein refers to the motion of the antenna 202. In some embodiments, the antenna 202 can be separate from the positioning module 108. In such a situation, the motion estimate used in the motion compensated correlation process is the motion of the antenna 202. In most scenarios, the motion of the positioning module 108 is the same as the motion of the antenna 202 and, as such, the following description will assume that the motion of the positioning module 108 and antenna 202 are the same.

The positioning module 108 comprises a receiver front end 204, a signal processor 206 and a motion module 208. The receiver front end 204 down-converts, filters, and samples (digitizes) the received signals in a manner that is well-known and as such will not be described in detail herein. The output of the receiver front end 204 is a digital signal containing data. In some embodiments, the data of interest is a deterministic training or acquisition code used by the transmitter to synchronize the transmission to a receiver, e.g., a WiFi transceiver.

The signal processor 206 comprises at least one processor 210, support circuits 212 and memory 214. The at least one processor 210 can be any form of processor or combination of processors including, but not limited to, central processing units, microprocessors, microcontrollers, field programmable gate arrays, graphics processing units, digital signal processors, and the like. The support circuits 212 can comprise well-known circuits and devices facilitating functionality of the processor(s). The support circuits 212 can comprise one or more of, or a combination of, power supplies, clock circuits, analog to digital converters, communications circuits, cache, displays, and/or the like.

The memory 214 can comprise one or more forms of non-transitory computer readable media including one or more of, or any combination of, read-only memory or random-access memory. The memory 214 stores software and data including, for example, signal processing software 216, positioning software 232 and data 218. The data 218 comprises at least the receiver location 220, direction of arrival (DoA) vectors 222 (collectively, DoA data), transmitter location 224, motion information 226, a room map or floorplan 228, and various other data used to perform the SUPERCORRELATION™ processing. The signal processing software 216, when executed by the one or more processors 210, performs motion compensated correlation upon the received signals to estimate the DoA vectors for the received signals. The motion compensated correlation process is described in further detail below.

As described below in detail, the DoA vectors 222 and receiver position 220 are used by the positioning software 232 to improve the accuracy of the receiver position. The data 218 stored in memory 214 can also include signal estimates, correlation results, motion compensation information, motion information, motion and/or other receiver parameter hypotheses, position information and the like (e.g., other data 230).

The motion module 208 generates a motion estimate for the antenna 202. The motion module 208 can comprise an inertial navigation system (INS) 234 as well as a global navigation satellite system (GNSS) receiver 236 such as GPS, GLONASS, GALILEO, DEIBOU, etc. The INS 234 can comprise one or more of, but not limited to, a gyroscope, a magnetometer, an accelerometer, and the like. To facilitate motion compensated correlation, the motion module 208 produces motion information (sometimes referred to as a motion model) comprising at least a velocity of the antenna 202 in the direction of interest (i.e., an estimated direction of a source of a received signal or a reflection point of a received reflected signal). In some embodiments, the motion information can also include estimates of platform orientation or heading including, but not limited to, pitch, roll and yaw of the module 200/antenna 202. As described in more detail below, the receiver 102 can test every direction and iteratively narrow the search to one or more directions of interest. In some embodiments, the receiver 102 uses a priori knowledge of the receiver position, room dimensions, transmitter location, and the like to narrow the range of parameters to be searched.

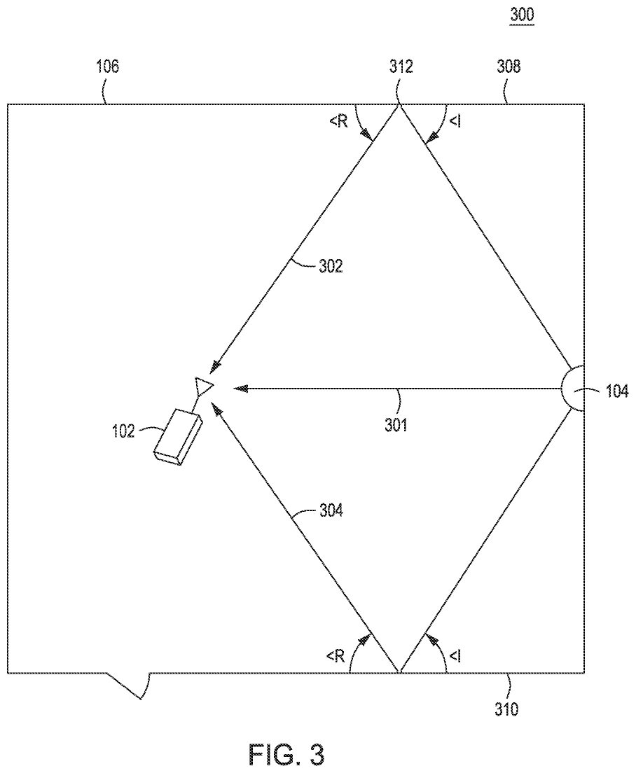

FIG. 3 depicts the operation of a receiver of the present principles, such as the receiver 102 of FIGS. 1 and 2, in a communication room 300 in accordance with at least one embodiment of the present principles. In the embodiment of FIG. 3, as the receiver 102 traverses the area, the receiver 102 computes DoA vectors 300, 302 and 304 (for simplicity only three vectors are depicted). As depicted in FIG. 3, the three DoA vectors 300, 302, 304 intersect at the location of the receiver 102. Although in FIG. 3 three vectors are computed, in alternate embodiments of the present principles, receiver position can be calculated with as few as two received signals. In various embodiments, the DoA vectors can be computed periodically, intermittently, or continuously as the receiver 102 moves. Additional vectors can be used to converge the solution onto an accurate location for the receiver 102. In some embodiments of the present principles, the DoA vectors can be processed at a remotely located server to improve the accuracy of the position of the receiver 102.

In some embodiments, such as in an urban environment, some DoA vectors 301 are derived from a combination of line-of-sight (LOS) signals and/or some DoA vectors 302 and 304 are derived from non-line-of-sight (NLOS) signals. That is, LOS vectors represent signals that are transmitted directly from the transmitter 104 to the receiver 102, while NLOS vectors can be reflected from structures (e.g., walls of a room 106) in the vicinity of the receiver 102.

In some embodiments of the present principles, the structures causing reflections can be modeled in a building model, such as a floorplan or map. The model in conjunction with ray tracing techniques can be used to estimate the DoA of reflected signals. Consequently, the path of the reflected transmitter signal can be estimated, and the reflected signals can be used in a calculation of a position of the receiver 102. It should be noted that in some embodiments, some signals can be reflected multiple times before being received.

In other embodiments, one or more receivers 102 can collect transmitter signals, LOS and NLOS, from one or more transmitters over a period of time while the receiver(s) are traversing an area. The collected signals can be processed using the receiver positioning techniques described herein to create a signal profile for a region. In some embodiments, the signal profile can contain DoA vector intersection regions that identify positions of the one or more receivers over time.

In some embodiments of the present principles, when using a DoA positioning technique, a vector intersection location is not a point, but rather a region or area due to the probabilistic nature of the DoA vectors. That is, the direction of each vector has an error distribution and the intersection forms a region rather than a point. In such embodiments, the region will have a maximum that defines the position of the receiver 102.

In the embodiment described directly above, the receiver vector and position determination is performed within the receiver 102. In alternate embodiments of the present principles, the data (e.g., transmitter data) for producing DoA vectors, DoA vectors themselves, position information, etc. can be transmitted from, for example, the receiver 102 to a remote server for processing to produce a position for the receiver 102.

In operation, the receiver 102 performs the SUPERCORRELATION™ technique to motion compensate the received signals arriving from the transmitter 104. As depicted in FIG. 3, these signals can arrive unimpeded as a direct LOS signal 301. Other signals along paths 302 and 304 reflect from the walls (e.g., 308 and 310) and arrive at the receiver 102 as NLOS signals. For example, in the embodiment of FIG. 3, the transmitted radio signal leaves the transmitter 104 and propagates to the wall 308 where the signal contacts the wall 308 at an angle of incidence (<I). The reflected signal leaves the wall 308 at an angle of reflection (<R) that is equal to <I. At a point 312 along the wall, the transmitted signal reflects from the wall and the signal on path 302 is received by the receiver antenna. A similar reflective process occurs for a signal from the transmitter 104 that contacts wall 310 and traverses along signal path 304. The DoA of these signals forms the DoA vectors computed by the receiver 102. To improve clock error and position calculations, the receiver 102 can select only signals having reflection angles in a specific range to ensure that a DoA determination results from a small angle of reflection, e.g., less than 50 degrees with respect to the normal to the reflecting surface. Signals with a large angle of reflection can be difficult to differentiate from direct signals and result in erroneous position calculations.

To determine an accurate position for the receiver 102, the receiver 102 can begin having a general understanding of its position from the motion module and an accurate understanding of the motion of the receiver 102. The receiver 102 can also have knowledge of the floorplan of a room being traversed and an accurate location of the transmitter. The receiver 102 receives the signals from the transmitter 104 and correlates those signals with locally generated signals to determine correlation results. In some embodiments, the correlation result of each received signal can be used to produce a time of arrival for each signal. These correlation results are motion compensated using the receiver motion to correct for doppler and doppler rate changes due to the motion of the receiver 102 and extend the coherent integration period of the receiver such that accurate correlation results are used in determining time of arrival to a sub-wavelength level.

Since ray tracing provides only an estimate of the DoA, the DoA vectors require processing to enable accurate determination of a position of the receiver 102. That is, in some embodiments, the DoA vector estimates are used to define a search space of directions from which signals from the transmitter 104 can arrive. A receiver of the present principles produces a plurality of phasor sequence hypotheses, where each hypothesis represents a phasor sequence of signal phase that can occur for a signal arriving at a particular DoA. By testing each hypothesis, the receiver converges upon an accurate DoA for each signal. As such, a signal arriving from a particular direction can be isolated from other reflected signals and the isolated signal is processed with other isolated signals to generate an accurate position information for the receiver that can be used, for example, to improve a GNSS/INS generated approximate position. Without the use of a motion compensated correlation technique of the present principles (e.g., SUPERCORRELATION™), the narrowband signals could not be isolated to enable a single transmitter to facilitate position improvement for a receiver.

In some embodiments of the present principles, the hypotheses can be based on a previously determined preferred hypothesis. Since the true values of the hypotheses correlate strongly between repetitions, the search space of the hypotheses can be narrowed over time to make the search less intensive while still converging to the true value. The hypotheses can be offset from the previously determined preferred hypothesis based on an expected receiver motion. The hypotheses can be centered around a previously determined preferred hypothesis. Since the receiver is expected to move in a manner that obeys the laws of Physics, the hypotheses can be based on the expected (e.g. predicted) receiver motion. In this way, the number of hypotheses that need to be tested before determining a preferred hypothesis can be reduced.

The hypotheses can be further based on a local oscillator frequency error. The local oscillator frequency error can be referred to as the clock error. The local oscillator is typically used to generate the local signals and is typically a component of the receiver. The clock error is typically common to all the received signals. The hypotheses can therefore compensate or remove the clock error in order to enable calculation of a more accurate receiver position in accordance with the present principles. The clock error can be determined using techniques known in the art.

In some embodiments of the present principles, a preferred hypothesis can correspond to a hypothesis that provides a compensated correlation result with the strongest signal-to-noise ratio or highest power. Determining a preferred hypothesis can include performing a mathematical optimization process across the plurality of compensated correlation results in order to find the compensated correlation result with the strongest signal-to-noise ratio or the highest power (e.g. the optimal or “best” correlation result). This can include producing a joint correlation output as a function (e.g., summation) of the plurality of correlation results resulting from all the hypotheses and received transmitter signals.

Alternatively or in addition, in some embodiments, the preferred hypothesis can be determined based on a cost function and in particular by minimizing the cost function. The cost function can be applied to each set of correlation values for each received signal to find the optimal (e.g. highest power) correlation output corresponding to a preferred hypothesis or hypotheses. In this way, the direction of arrival for each received signal can be determined based on the preferred hypothesis for that signal.

In some embodiments of the present principles, the direction of arrival estimate for each phasor sequence can be based on one or more of: a known position of the transmitter, a known building model, an approximate position of the receiver. The approximate position of the receiver can be provided by one or more of: a global navigation satellite receiver, an inertial navigation system, a landmark within the known building model. The known building model can be a map or floor plan of a room or can be a map of an urban canyon having buildings or other reflective surfaces. Estimating the direction of arrival in accordance with the present principles can be particularly useful to provide an initial estimate for the direction of arrival, such as shortly after initialization of the receiver.

A phasor sequence comprises a sequence of phasors that each comprise a phase angle and an amplitude based upon the motion of the antenna at a particular time t. Each phasor sequence is indicative of the phase and/or amplitude changes introduced into the received signal as a result of the component of the antenna motion along a particular direction as a function of time. The phasor sequence can also be indicative of other system parameters such as clock error. A compensated correlation result based on a phasor sequence indicative of the antenna motion along a particular direction (e.g. the component of the antenna motion along a particular direction) will exhibit preferential gain for a signal received along that direction in comparison with a signal that is not received along that direction. Therefore, a phasor sequence that represents the component of the antenna motion along a particular direction is indicative of a direction of arrival hypothesis for that direction. For a particular correlation of a local signal with a received signal to produce a correlation result, a phasor sequence can be used to compensate at least one of the local signal, the received signal, and the correlation result, in order to generate a compensated correlation result. In some embodiments, In some embodiments, the local signals can be generated using a frequency reference provided by a local oscillator (e.g. a quartz crystal) that can be a component of the receiver.

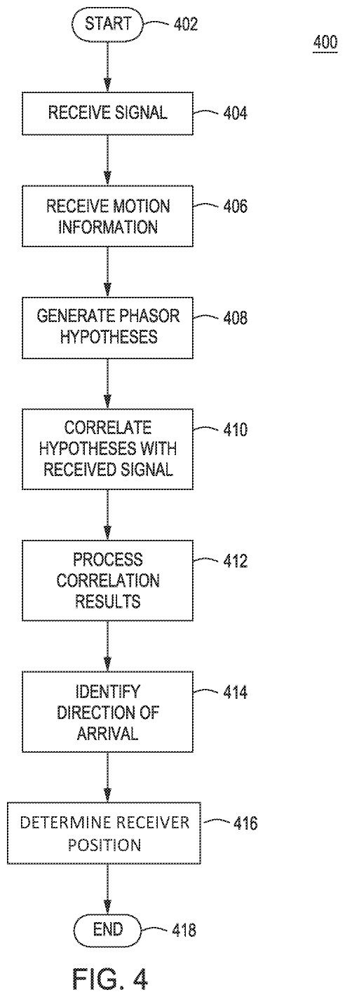

FIG. 4 depicts a flow diagram of a method 400 for determining a position of a receiver using signals transmitted from a single transmitter in accordance with an embodiment of the present principles. In some embodiments of the present principles, the method 400 can be performed by the signal processing software 216 of a receiver of the present principles, such as the receiver 102. In some embodiments, the method 400 can be implemented in software, hardware or a combination of both, for example, using the signal processor 206 of the receiver 102 of FIG. 2.

The method 400 begins at 402 and proceeds to 404 where at least two signals are received at a receiver from a remote source (e.g., transmitter 104) in a manner as described with respect to FIGS. 1A, 1B, 2 and 3. Each received signal comprises a synchronization or acquisition code, i.e., a deterministic code, extracted from the radio frequency (RF) signal received at the antenna. The digital code is extracted and the signal is down-converted. The method 400 can proceed to 406.

At 406, motion information is determined for an antenna of the receiver. For example and as described above, motion of an antenna of the receiver can be determined using the motion module 208 of the receiver 102 as depicted in at least FIG. 2. That is, the motion information comprises an estimate of the motion of the receiver 102 of FIGS. 1A and 1B, for example, including one or more of velocity, heading, orientation, etc. The method 400 can proceed to 408.

At 408, a plurality a of phasor sequences are generated, where each phasor sequence represents a hypothesis related to a direction of interest of the received signal, e.g., direction of the transmitter or direction of one or more reflections. In some embodiments and as described above, these hypotheses comprise a plurality of local signals representing code phase estimates. Each phasor sequence hypothesis comprises a series of phase offsets that vary with parameters of the receiver such as motion, frequency, DoA of the received signals, and the like.

The signal processing correlates a local code encoded in a local signal with a code encoded in the received RF signal. In one embodiment, the phasor sequence hypotheses are used to adjust, at a sub-wavelength accuracy, the carrier phase of the local code over one or more periods (lengths) of the received code. Such adjustment or compensation can be performed by adjusting a local oscillator signal (i.e., generated by a local signal generator, such as a frequency synthesizer, using a frequency reference provided by a local oscillator of the receiver), the received signal(s), or the correlation result to produce a phase compensated correlation result. The signals and/or correlation results are complex signals comprising in-phase (I) and quadrature phase (Q) components. Each phase offset in the phasor sequence can be applied to a corresponding complex sample in the signals or correlation results. If the phase adjustment is or includes an adjustment for receiver motion, then the result is a motion compensated correlation result.

For each received signal, the received signals are correlated with a set (plurality) of direction hypotheses containing estimates of a phase offset necessary to accurately correlate the received signals arriving from particular directions. There is a set of hypotheses representing a search space for each received signal and each parameter of interest, e.g., motion, frequency, frequency rate, DoA, etc. The motion estimates are typically hypotheses of the motion in a direction of interest such as in the direction of the transmitter or a direction of a reflection of interest. At initialization, the direction of interest (e.g., DoA of the received signals) can be inaccurately estimated using ray tracing based on the known position of the transmitter and the known floor plan. Over time, as the hypotheses for DoA are tested, the receiver converges on an accurate DoA. As the receiver moves, the motion information is used to anticipate the direction change for the signals and alter the hypothesis search space accordingly. In some embodiments, there is very strong correlation between the true values of these hypotheses between code repetition, such that the initial search might be intensive, but subsequent processing only requires tracking of the parameters in the receiver as they evolve. Consequently, subsequent phase compensation is performed over a narrow search space.

In one embodiment, since the signal is received from a single transmitter, the set of hypotheses for newly received signals from the transmitter include a group of phasor sequence hypotheses using the expected Doppler and Doppler rate and/or last Doppler and last Doppler rate used in receiving the prior signal from that transmitter. The values can be centered around the last values used or the last values used additionally offset by a prediction of further offset based on the expected receiver motion. The method 400 can proceed to 410.

At 410, the received signals, a plurality of local signals or correlation results from correlating the received signals with the local signals using the plurality of phasor sequences are correlated based on the plurality of hypotheses regarding the receiver motion and the direction of arrival to generate a plurality of compensated correlation results. That is, at 410 each received signal is correlated with that signal's set of hypotheses. The hypotheses are used as parameters to form the phase-compensated phasors to phase compensate the correlation process. As such, the phase compensation can be applied to the received signals, the local frequency source (e.g., an oscillator), or the correlation result values. The hypotheses collectively form an N^{V} search space, where N is the number of hypotheses and V is the number of variables (parameters) that need to be defined. In addition to searching over the DoA and receiver motion space, the hypotheses related to other parameters such as oscillator frequency can be applied to correct frequency and/or phase drift, or heading to ensure the correct motion compensation is being applied. The result of the correlation process is a plurality of phase-compensated correlation results—one phase-compensated correlation result value for each hypothesis for each received signal. The method 400 can proceed to 412.

At 412, a preferred hypothesis in the plurality of hypotheses is determined for each received signal that optimizes each correlation result in the plurality of compensated correlation results. That is, at 412 the correlation results are processed to find the “best” or optimal result for each received signal, i.e., isolate each signal using an optimal DoA hypothesis. In one embodiment, a joint correlation output is produced as a function (e.g., summation) of the plurality of correlation results resulting from all the hypotheses and received transmitter signals. The joint correlation output may be a single value or a plurality of values that represent the parameter hypotheses (preferred hypotheses) that provide an optimal or best correlation output. In some embodiments, a cost function can be applied to each set of correlation values for each received signal to find the optimal correlation output corresponding to a preferred hypothesis or hypotheses. The method 400 can proceed to 414.

At 414, a direction of arrival is identified for the plurality of received signals using the preferred hypothesis. That is, at 414 the DoA vector of each received signal is identified from the optimal correlation result for the signal. The received signals along the DoA vector typically have the strongest signal to noise ratio and represent line of sight (LOS) propagation or NLOS propagation having a single reflection point. As such, in some embodiments, using motion compensated correlation enables the receiver 102 to identify the DoA vector of the received signal(s).

In other embodiments, rather than using the largest magnitude correlation value, other test criteria can be used. For example, the progression of correlations can be monitored as hypotheses are tested and a cost function can be applied that indicates the best hypotheses when the cost function reaches a minimum (e.g., a small hamming distance amongst peaks in the correlation plots). As such, the joint correlation output can be a joint correlation value or a group of values. In other embodiments, additional hypotheses can be tested in addition to the DoA hypotheses to, for example, ensure the motion compensation (i.e., speed and heading) is correct. The method 400 can proceed to 416.

At 416, a position of the receiver is determined from the direction of arrival of each received signal in the plurality of received signals. The method 400 can end at 418.

As described above, in some embodiments of the present principles, the direction of arrival estimate for each phasor sequence is based on one or more of a known position of the transmitter, a known building model, and/or a known, approximate position of the receiver.

In some embodiments of the present principles, the hypotheses are based on a previously determined preferred hypothesis and the hypotheses are offset from the previously determined preferred hypothesis based on an expected receiver motion. In addition, the hypotheses are further based on a local oscillator frequency error.

In some embodiments of the present principles, signals to be used are selected based on an angle of reflection of the signal. For example, in such embodiments, the signals are selected if the signals are determined to have an angle of reflection that is less than 50 degrees with respect to the normal to the reflecting surface.

In some embodiments of the present principles, the position of the receiver is determined further based on one or more of a transmission time stamp, a received signal time stamp, an estimated transmission path length, a transmitter position, a reflection position, a building model, a time difference of arrival between received signals, and a signal strength of received signals. For example, the direction of arrival can be combined with a room map and a known transmitter location to determine the location of the receiver, such as by using the intersection of the direction of arrival vectors for the received signals. In some embodiments of the present principles, time of arrival and time difference of arrival techniques can be used to improve the determined receiver position. For example, particular signals may be selected for the time of arrival processing. In addition, in some embodiments, signal strength can be used to improve or augment the position calculation using direction of arrival and/or time of arrival.

In some embodiments of the present principles, signals can be received at a receiver of the present principles from two or more transmitters, respective positions for the receiver can be determined using signals received from each of the two or more transmitters, and the receiver positions determined using each of the two or more transmitters can be combined to determine a receiver position.

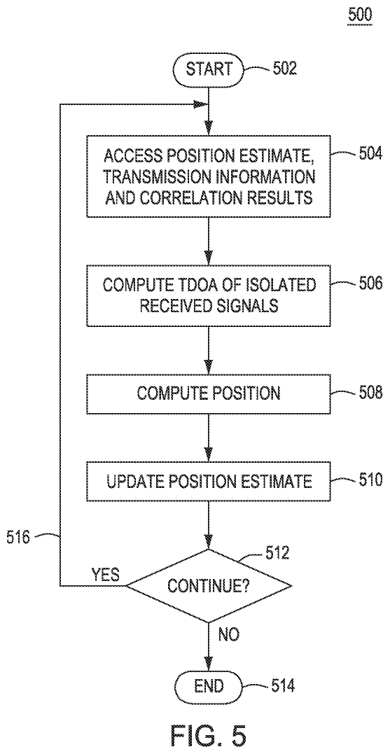

FIG. 5 depicts a flow diagram of a method 500 of operation of the positioning software 232 in accordance with at least one embodiment of the present principles. The method 500 can be performed locally within the receiver or can be performed remotely on a server. If performed remotely, the estimated receiver position, correlation results for the isolated received signals, and other information are transmitted from the receiver to the remote server for processing in accordance with method 500.

The method 500 begins at 502 and proceeds to 504 during which a receiver position estimate, transmission information and the correlation results for the isolated received signals are accessed. In some embodiments, the position estimate is the best-known current position of the receiver (i.e., an initial approximate position, the immediately prior position calculation, or an average of several prior position calculations). The transmission information comprises any information regarding the transmitter and the transmission paths of the isolated signals that is required to compute position from the received signals. For example, depending on the method used to compute the position, the transmission information can include, but is not limited to, one or more of the following: a transmission time stamp, a received signal time stamp, an estimated transmission path length, a transmitter position, and a reflection position, etc. The method 500 can proceed to 506.

At 506 a time difference of arrival (TDOA) for the isolated received signals is determined based on the motion compensated correlation results and the transmission information. In some embodiments of the present principles, in lieu of the TDOA information, direction or angle of arrival information or time of arrival information, or time of flight, or other positioning metrics known to those skilled in the art can be produced. In general, at 506 whatever information is required to compute the receiver position is produced. The method 500 can proceed to 508.

At 508, using the time difference of arrival information for each received signal, a position of the receiver is computed. Alternatively or in addition, in some embodiments, time of arrival or direction/angle of arrival techniques, or any other localization techniques can be used to compute the position. The method 500 can proceed to 510.

At 510, the position estimate is updated with the computed receiver position. The method 500 can proceed to 512.

At 512, it is determined whether additional signals exist for continuing to determine receiver positions. If the query is affirmatively answered, the method 500 returns to 504. If the query is negatively answered, the method 500 ends at 514.

In some embodiments of the present principles, an apparatus for providing a position of a receiver using signals transmitted from a single transmitter includes at least one processor and at least one memory for storing instructions. In such embodiments, when the instructions are executed by the at least one processor, it causes the apparatus to perform operations including receiving a plurality of signals transmitted from a single transmitter, where each of the plurality of signals has a different propagation path, determining a motion of an antenna of the receiver, generating a plurality of phasors sequences, where each phasor sequence represents a hypothesis based on antenna motion and a direction of arrival estimate for each of the plurality of the received signals, compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results, determining a preferred hypothesis in the plurality of hypotheses for each received signal that optimizes each correlation result in the plurality of compensated correlation results, identifying a direction of arrival for the plurality of received signals using the determined hypothesis, and determining a position of the receiver from the direction of arrival of each received signal in the plurality of received signals.

In some embodiments of the present principles, a system for providing a position of a receiver using signals transmitted from a single transmitter includes at least one receiver, comprising a respective antenna, a motion module, the single transmitter; and an apparatus including at least one processor and at least one memory for storing instructions. In such embodiments, when the instructions are executed by the at least one processor, it causes the apparatus to perform operations including receiving a plurality of signals transmitted from a single transmitter, where each of the plurality of signals has a different propagation path, determining a motion of an antenna of the receiver, generating a plurality of phasors sequences, where each phasor sequence represents a hypothesis based on antenna motion and a direction of arrival estimate for each of the plurality of the received signals, compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results, determining a preferred hypothesis in the plurality of hypotheses for each received signal that optimizes each correlation result in the plurality of compensated correlation results, identifying a direction of arrival for the plurality of received signals using the determined hypothesis, and determining a position of the receiver from the direction of arrival of each received signal in the plurality of received signals.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with a computing device via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be anon-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

Any block, step, module, or otherwise described herein may represent one or more instructions which can be stored on non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present principles, other and further embodiments of the present principles may be devised without departing from the basic scope thereof, and the scope thereof is determined by the claims that follow.

1. A method for providing a position of a receiver using signals transmitted from a single transmitter, comprising:
receiving a plurality of signals transmitted from the single transmitter, where each of the plurality of signals has a different propagation path;
determining a motion of an antenna of the receiver;
generating a plurality of phasors sequences, where each phasor sequence represents a hypothesis based on antenna motion and a direction of arrival estimate for each of the plurality of the received signals;
compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results;
determining a preferred hypothesis in the plurality of hypotheses for each received signal that optimizes each correlation result in the plurality of compensated correlation results;
identifying a direction of arrival for the plurality of received signals using the preferred hypothesis; and
determining a position of the receiver using the direction of arrival of each received signal in the plurality of received signals.

2. The method of claim 1, wherein the direction of arrival estimate for each phasor sequence is based on at least one of a known position of the transmitter, a known building model, or an approximate position of the receiver.

3. The method of claim 1, wherein the hypotheses are based on a previously determined preferred hypothesis.

4. The method of claim 3, wherein the hypotheses are offset from the previously determined preferred hypothesis based on an expected receiver motion.

5. The method of claim 1, wherein determining the motion of the antenna includes determining at least one of a velocity, a heading, or an orientation of the antenna.

6. The method of claim 1, wherein signals are selected for processing if the signals are determined to have an angle of reflection that is less than 50 degrees.

7. The method of claim 1, wherein the preferred hypothesis is determined based on a cost function.

8. The method of claim 1, wherein the position of the receiver is determined further based on at least one of a transmission time stamp, a received signal time stamp, an estimated transmission path length, a transmitter position, a reflection position, a building model, a time difference of arrival between received signals, or a signal strength of received signals.

9. The method of claim 1, further comprising receiving signals transmitted from two or more transmitters, determining respective positions for the receiver using signals received from each of the two or more transmitters, and combining the receiver positions determined using each of the two or more transmitters to determine a receiver position.

10. An apparatus for providing a position of a receiver using signals transmitted from a single transmitter, comprising:
at least one processor; and
at least one memory for storing instructions that, when executed by the at least one processor, causes the apparatus to perform operations comprising:
receiving a plurality of signals transmitted from a single transmitter, where each of the plurality of signals has a different propagation path;
determining a motion of an antenna of the receiver;
generating a plurality of phasors sequences, where each phasor sequence represents a hypothesis based on antenna motion and a direction of arrival estimate for each of the plurality of the received signals;
compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results;
determining a preferred hypothesis in the plurality of hypotheses for each received signal that optimizes each correlation result in the plurality of compensated correlation results;
identifying a direction of arrival for the plurality of received signals using the determined hypothesis; and
determining a position of the receiver using the direction of arrival of each received signal in the plurality of received signals.

11. The apparatus of claim 10, wherein the direction of arrival estimate for each phasor sequence is based on at least one of a known position of the transmitter, a known building model, or an approximate position of the receiver.

12. The apparatus of claim 10, wherein the hypotheses are based on a previously determined preferred hypothesis and the hypotheses are offset from the previously determined preferred hypothesis based on an expected receiver motion.

13. The apparatus of claim 10, wherein determining the motion of the antenna includes determining at least one of a velocity, a heading, or an orientation of the antenna.

14. The apparatus of claim 10, wherein signals are selected for processing if the signals are determined to have an angle of reflection angle that is less than 50 degrees.

15. The apparatus of claim 10, wherein the position of the receiver is determined further based on at least one of a transmission time stamp, a received signal time stamp, an estimated transmission path length, a transmitter position, a reflection position, a building model, a time difference of arrival between received signals, or a signal strength of received signals.

16. The apparatus of claim 10, wherein the apparatus further performs the operations of receiving signals transmitted from two or more transmitters, determining respective positions for the receiver using signals received from each of the two or more transmitters, and combining the receiver positions determined using each of the two or more transmitters to determine a receiver position.

17. A system for providing a position of a receiver using signals transmitted from a single transmitter, comprising:
at least one receiver comprising a respective antenna;
a motion module;
the single transmitter; and
an apparatus comprising at least one processor and at least one memory for storing programs and instructions that, when executed by the at least one processor, causes the apparatus to perform operations comprising:
receiving at the antenna of the at least one receiver a plurality of signals transmitted from the single transmitter, where each of the plurality of signals has a different propagation path;
determining a motion of the antenna of the receiver;
generating a plurality of phasors sequences, where each phasor sequence represents a hypothesis based on antenna motion and a direction of arrival estimate for each of the plurality of the received signals;
compensating the received signals, a plurality of local signals or correlation results from correlating the received signals with the local signals using the plurality of phasor sequences based on the plurality of hypotheses regarding the receiver motion and the direction of arrival to generate a plurality of compensated correlation results;
determining a preferred hypothesis in the plurality of hypotheses for each received signal that optimizes each correlation result in the plurality of compensated correlation results;
identifying a direction of arrival for the plurality of received signals using the determined hypothesis; and
determining a position of the receiver using the direction of arrival of each received signal in the plurality of received signals.

18. The system of claim 17, wherein the direction of arrival estimate for each phasor sequence is based on at least one of a known position of the transmitter, a known building model, or an approximate position of the receiver.

19. The system of claim 17, wherein the position of the receiver is determined further based on at least one of a transmission time stamp, a received signal time stamp, an estimated transmission path length, a transmitter position, a reflection position, a building model, a time difference of arrival between received signals, or a signal strength of received signals.

20. The system of claim 17, wherein the apparatus further performs the operations of receiving signals transmitted from two or more transmitters, determining respective positions for the receiver using signals received from each of the two or more transmitters, and combining the receiver positions determined using each of the two or more transmitters to determine a receiver position.
